(19) United States
(12) Patent Application Publication
(10) Pub. No.: US 2018/0178461 A1
(43) Pub. Date: Jun. 28, 2018

(54) 3D PRINTING APPARATUS USING SELECTIVE ELECTROCHEMICAL DEPOSITION

(71) Applicant: ANYCASTING CO., LTD., Seoul (KR)

(72) Inventors: Sungbin KIM, Seoul (KR); Bongyoung YOO, Seongnam-si (KR)

(73) Assignee: ANYCASTING CO., LTD., Seoul (KR)

(21) Appl. No.: 15/437,403

(22) Filed: Feb. 20, 2017

(30) Foreign Application Priority Data
Dec. 22, 2016 (KR) 10-2016-0176781
Dec. 22, 2016 (KR) 10-2016-0176800

(51) Int. Cl. B29C 67/00; C25D 5/02; B29C 67/24

(52) U.S. Cl. CPC B29C 67/0081; C25D 5/026; B29C 67/24; B29C 67/0088; B29C 67/0059

(57) ABSTRACT

A three-dimensional (3D) printing apparatus using selective electrochemical deposition is provided. The 3D printing apparatus is used to selectively deposit a metallic material on a substrate using a nozzle for jetting an electrolyte at a predetermined pressure to enhance 3D printing speed of a metallic product stacked on the substrate. The 3D printing apparatus is configured in such a way that a metallic product is 3D-printed as a metallic material is selectively deposited on the substrate while the electrolyte is continuously jetted at a predetermined pressure and, thus, 3D printing speed of a metallic product stacked on the substrate is remarkably increased compared with the case according to the prior art (Korean Publication No. 10-2015-0020356) in which plating is performed only when a meniscus is formed. Accordingly, the 3D printing apparatus is also applied to 3D printing of a bulk type of a metallic product with a comparatively large shape.

### CROSS-REFERENCE TO RELATED APPLICATIONS

This application claims priority from Korean Patent Application Nos. 10-2016-0176781 and 10-2016-0176800, filed on Dec. 22, 2016, in the Korean Intellectual Property Office, the disclosure of which is incorporated herein by reference in its entirety.

### BACKGROUND OF THE INVENTION

### Field of the Invention

Apparatuses and methods consistent with the present invention relate to a three-dimensional (3D) printing apparatus using selective electrochemical deposition, and more particularly, to a 3D printing apparatus for selectively depositing a metallic material on a substrate using a nozzle for jetting an electrolyte at a predetermined pressure to enhance 3D printing speed of a metallic product stacked on the substrate.

### Description of the Related Art

Three-dimensional (3D) printing technology allows production of mock-ups, prototypes, tools, components, and so on via additive manufacturing for stacking materials such as polymeric materials, plastics, or metallic powders based on 3D design data.

As a 3D printing method, a liquid-based method and a powder-based method are mainly used according to properties of used materials. The liquid-based method is a method of stacking polymer synthetic resin in a liquid state on a layer-by-layer basis according to a material shape and then hardening a stacked structure and the powder-based method is a method of melting or sintering a powdered metallic material.

Thereamong, a 3D printer using a polymeric material, plastic, or the like as a base material is embodied using the liquid-based method and has been widely used. On the other hand, in the case of a metallic material, it is difficult to embody a printer using the metallic material using the liquid-based method and the printer is mainly embodied only using the powder-based method and, accordingly, the printer has not been widely used unlike the 3D printer using a plastic material due to, for example, material costs, a complicated processing method, a high sintering temperature, and explosion risk.

In order to overcome this problem, the 3D printing apparatus according to the prior art uses a method of plating a substrate with metallic ions in meniscus by applying a voltage to the meniscus when the meniscus of a metallic solution is formed between the substrate and a printing pen that discharges the metallic solution.

The 3D printing apparatus using the above method according to the prior art is advantageous in that a high-temperature application process for sintering a metallic material is not required unlike a conventional powder-based method that has been mainly used in the case of a metallic material.

However, the 3D printing apparatus according to the prior art uses a method of plating a substrate only when a meniscus is formed between a printing pen and the substrate and, thus, there is a problem in that the 3D printing apparatus is not appropriate for 3D printing of a bulk type of a metallic product with a comparatively large shape.

That is, meniscus refers to a phenomenon that occurs on a liquid surface that is raised or lowered according to the capillary phenomenon due to surface tension in a pipe and speed for supplying metallic ions supplied to the meniscus is dependent only upon diffusion. Accordingly, when a substrate is plated only when a meniscus is formed as in the prior art, 3D printing speed of metallic products stacked on the substrate is also inevitably dependent upon diffusion speed of metallic ions and, accordingly, the 3D printing apparatus according to the prior art is not appropriate for 3D printing of a bulk type of a metallic product with a comparatively large shape due to very low printing speed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a three-dimensional (3D) printing apparatus that enhances 3D printing speed of metallic products stacked on a substrate without necessity of a high-temperature application process of sintering a metallic material.

According to an aspect of the present invention, a three-dimensional (3D) printing apparatus includes a substrate, a nozzle assembly configured to jet an electrolyte to the substrate at a predetermined pressure through a nozzle installed at an end portion of the nozzle assembly, a power supply configured to apply a voltage or current to the electrolyte jetted through the nozzle using a first electrode that has a contact point with the electrolyte jetted through the nozzle and the substrate that is a second electrode to form a deposition region on a region of the substrate, corresponding to a jetted surface of the jetted electrolyte, an input unit through which 3D printing data of a metallic product as a 3D printing target is input, a first driver configured to move the nozzle assembly so as to change a location of the nozzle through which the electrolyte is jetted, a reservoir configured to store the electrolyte jetted to the substrate, an electrolyte supplier configured to supply the electrolyte stored in the reservoir to the nozzle assembly at a predetermined pressure, and a controller configured to control the first driver and the power supply according to 3D printing data input through the input unit to selectively stack the deposition region deposited on the substrate.

The 3D printing apparatus may further include a temperature adjuster disposed between the reservoir and the nozzle assembly and configured to adjust a temperature of the electrolyte supplied to the nozzle assembly by the electrolyte supplier, and a temperature sensor configured to detect the temperature of the electrolyte supplied to the nozzle assembly by the electrolyte supplier, wherein the controller may control the temperature adjuster according to detection of the temperature sensor to adjust the temperature of the electrolyte jetted through the nozzle.

The 3D printing apparatus may further include a measurer configure to measure a voltage or current between the first electrode and the substrate as the second electrode, and a gap adjuster configured to adjust a gap between the substrate and an end portion of the nozzle, wherein the controller may control the gap adjuster according to measurement of the measurer to adjust the gap between the substrate and the end portion of the nozzle.

The 3D printing apparatus may further include a discharge nozzle configured to discharge liquid or gas around the deposition region at a predetermined pressure.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is a schematic diagram illustrating a three-dimensional (3D) printing apparatus according to an exemplary embodiment of the present invention;

FIG. 2 is an enlarged diagram of a portion ‘A’ of FIG. 1;

FIG. 3 is a schematic diagram of a structure of the 3D printing apparatus of FIG. 1;

FIG. 4 is a diagram illustrating a state in which a deposition region is stacked to a predetermined height or more in FIG. 2;

FIG. 5 is a diagram for explanation of a 3D printing apparatus according to another exemplary embodiment of the present invention; and

FIGS. 6 and 7 are diagrams illustrating the discharge nozzle 100 in various forms.

### DETAILED DESCRIPTION OF THE EXEMPLARY EMBODIMENTS

Hereinafter, exemplary embodiments of the present invention will be described in detail by explaining exemplary embodiments of the invention with reference to the attached drawings.

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

In the drawings, the thicknesses of layers and regions are exaggerated for clarity. Accordingly, the present invention is not limited by the relative sizes and thicknesses illustrated in the accompanying drawings

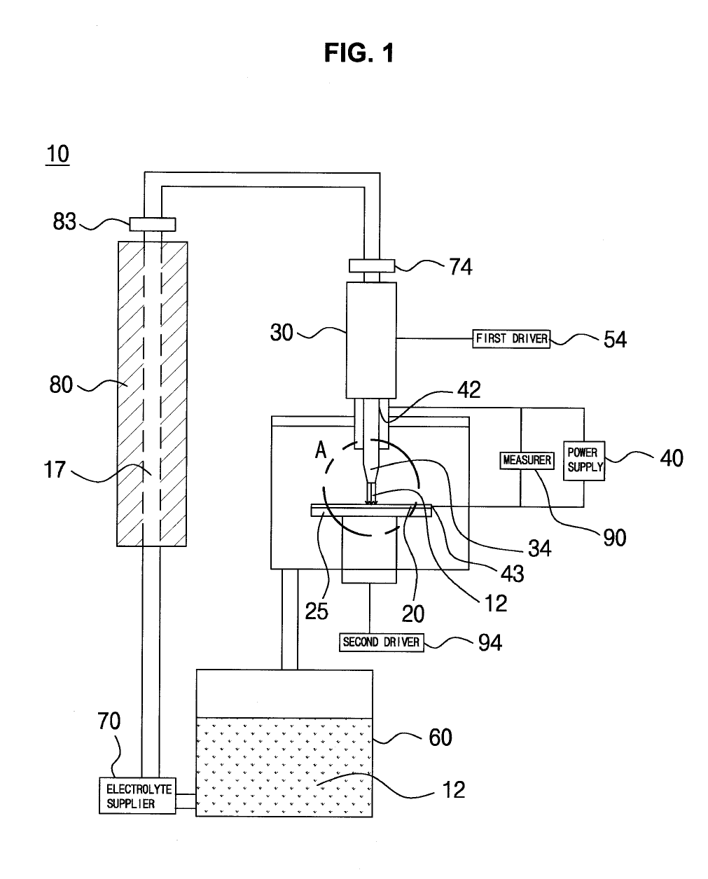

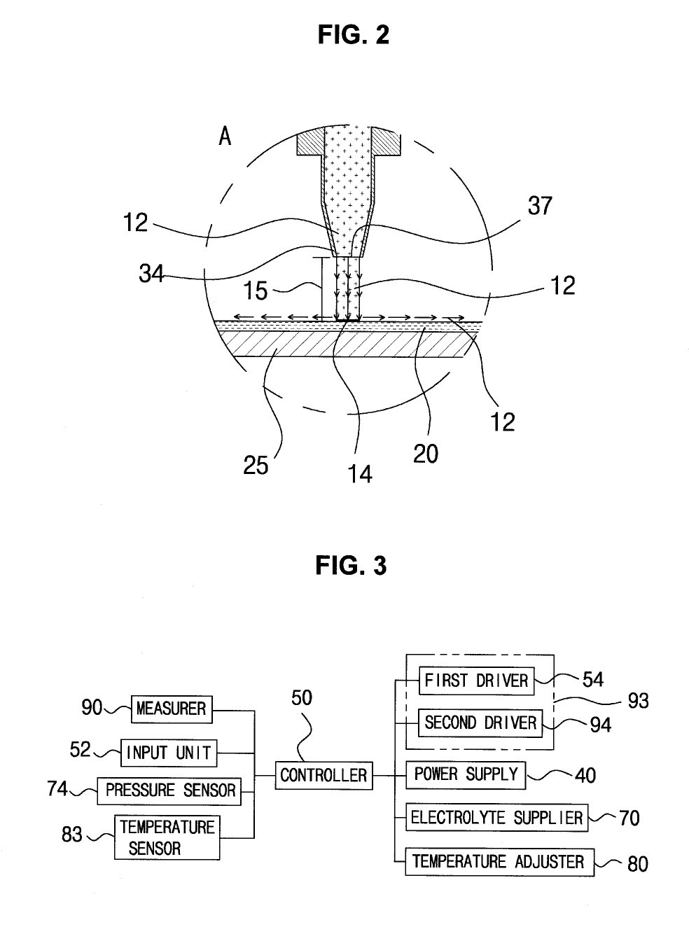

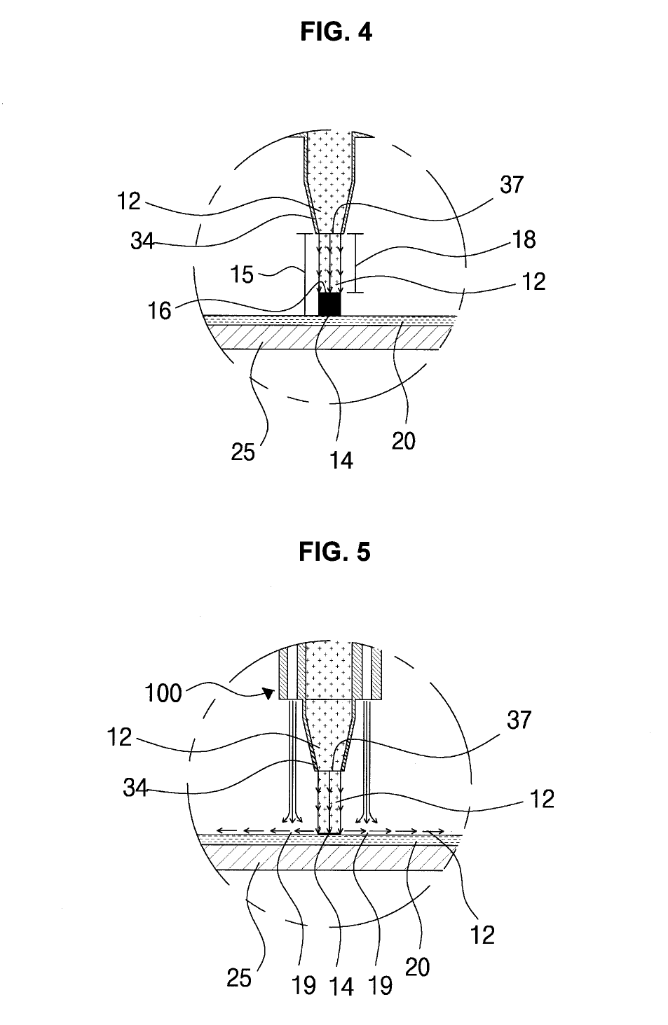

FIG. 1 is a schematic diagram illustrating a three-dimensional (3D) printing apparatus 10 according to an exemplary embodiment of the present invention. FIG. 2 is an enlarged diagram of a portion ‘A’ of FIG. 1. FIG. 3 is a schematic diagram of a structure of the 3D printing apparatus 10 of FIG. 1. FIG. 4 is a diagram illustrating a state in which a deposition region 14 is stacked to a predetermined height or more in FIG. 2.

Referring to FIGS. 1 to 4, the 3D printing apparatus 10 according to an exemplary embodiment of the present invention may include a substrate 20, a support 25 for supporting the substrate 20, a nozzle assembly 30, a power supply 40, a controller 50, an input unit 52, a first driver 54, a reservoir 60, and an electrolyte supplier 70.

The nozzle assembly 30 may jet an electrolyte 12 to the substrate 20 at a predetermined pressure through a nozzle 34 installed at an end portion of the nozzle assembly 30.

As such, when the electrolyte 12 is jetted at a predetermined pressure through the nozzle 34, the electrolyte 12 directed toward the substrate 20 may have appropriate straightness.

Then, as illustrated in FIG. 2, a region 14 in which a jetted surface of the electrolyte 12 jetted through the nozzle 34 comes in contact with the substrate 20 may have an appropriate size corresponding to a size of an end portion 37 of the nozzle 34.

The power supply 40 may apply a voltage or current to the electrolyte 12 jetted through the nozzle 34 using a first electrode 42 that has a contact point with the electrolyte 12 jetted through the nozzle 34 and the substrate 20 that is a second electrode 43.

Then, metallic ions included in the electrolyte 12 jetted through the nozzle 34 may be selectively deposited only in the region 14 in which a jetted surface of the electrolyte 12 comes in contact with the substrate 20.

That is, the 3D printing apparatus 10 according to the present invention may be configured to selectively perform deposition only in the deposition region 14 in which the jetted surface of the electrolyte 12, jetted through the nozzle 34 by the power supply 40, comes in contact with the substrate 20.

Here, the deposition region 14 may be a unit deposition region for 3D printing and an area of the unit deposition region 14 may be determined according to a size of a cross section of the end portion 37 of the nozzle 34 or a gap 15 between the substrate 20 and the end portion 37 of the nozzle 34.

For example, as the size of the cross section of the end portion 37 of the nozzle 34 is increased, the area of the unit deposition region 14 may be increased. This is because, when the size of the cross section of the end portion 37 of the nozzle 34 is increased, the size of a jetted surface of the electrolyte 12 jetted through the nozzle 34 is increased.

In addition, when the size of the cross section of the end portion 37 of the nozzle 34 is constant, as the gap 15 between the substrate 20 and the end portion 37 of the nozzle 34 is increased, the area of the unit deposition region 14 may be increased. This is because, when the gap 15 is increased, the jetted surface of the electrolyte 12, which comes in contact with the substrate 20, is increased compared with the size of the cross section of the end portion 37 of the nozzle 34 as the electrolyte 12 jetted through the nozzle 34 is spread up to the substrate 20.

The input unit 52 may be a component through which 3D printing data of a metallic product as a 3D printing target is input and the 3D printing data may include planar path data of the nozzle 34, for 3D-printing a metallic product in the unit deposition region 14.

The first driver 54 may be a component for moving the nozzle assembly 30 so as to change a location of the nozzle 34 through which the electrolyte 12 is jetted.

For example, the first driver 54 may change a location of the nozzle assembly 30 so as to move the nozzle 34 along the planar path according to data input through the input unit 52.

The controller 50 may be a component that controls the power supply 40 and the first driver 54 according to 3D printing data input through the input unit 52 to selectively stack the deposition region 14 deposited on the substrate 20.

For example, the controller 50 may drive the first driver 54 to move the nozzle 34 along the planar path according to data input through the input unit 52 so as to control the location of the nozzle assembly 30 and control the power supply 40 so as to selectively form the deposition region 14 deposited on the substrate 20.

The reservoir 60 may be a component for storing the electrolyte 12 jetted to the substrate 20.

The electrolyte supplier 70 may be a component that re-supplies the electrolyte 12 stored in the reservoir 60 to the nozzle assembly 30 and may include a pump for supplying the electrolyte 12 stored in the reservoir 60 to the nozzle assembly 30 at a predetermined pressure.

That is, the 3D printing apparatus 10 according to the present invention may be configured in such a way that metallic ions of the electrolyte 12 jetted through the nozzle 34 at a predetermined pressure are selectively deposited on the substrate 20 to form the deposition region 14 and the electrolyte 12 is continuously circulated until a concentration of the metallic ions of the electrolyte 12 reach a preset metallic ion threshold value (lower limit).

The 3D printing apparatus 10 according to an exemplary embodiment of the present invention may further include a pressure sensor 74 for detecting a pressure of the electrolyte 12 jetted through the nozzle 34 and the controller 50 may control the electrolyte supplier 70 according to the detection result of the pressure sensor 74 to control the pressure of the electrolyte 12 jetted through the nozzle 34.

For example, the 3D printing data input through the input unit 52 may include jet pressure range information of the electrolyte 12 and the controller 50 may control the electrolyte supplier 70 according to the detection result of the pressure sensor 74 such that a jet pressure of the electrolyte 12 jetted through the nozzle 34 is maintained in the jet pressure range included in the 3D printing data.

As described above, the 3D printing apparatus 10 according to an exemplary embodiment of the present invention is configured in such a way that a metallic product is 3D-printed as a metallic material is selectively deposited on the substrate 20 while the electrolyte 12 is continuously jetted at a predetermined pressure and, thus, 3D printing speed of a metallic product stacked on the substrate 20 may be remarkably increased compared with the case according to the prior art (Korean Publication No. 10-2015-0020356) in which plating is performed only when a meniscus is formed. Accordingly, the 3D printing apparatus 10 according to the present invention may also be applied to 3D printing of a bulk type of a metallic product with a comparatively large shape.

Like the 3D printing apparatus 10 according to an exemplary embodiment of the present invention, in 3D printing using a method of selectively performing deposition only in a region in which the electrolyte 12 jetted through the nozzle 34 at a predetermined pressure comes in contact with the substrate 20, that is, the deposition region 14, precise deposition in the deposition region 14 with a uniform thickness and area is an important factor in determining the quality of 3D printing of a metallic product as a target product.

That is, in the 3D printing apparatus 10 according to an exemplary embodiment of the present invention, it may be necessary to precisely form the deposition region 14 with a uniform thickness and area in order to enhance the 3D printing quality of a metallic product and, to this end, it may be necessary to precisely adjust a concentration, a pressure, and a temperature of metallic ions of the electrolyte 12 jetted through the nozzle 34 at a predetermined pressure, a gap between the substrate 20 and the end portion 37 of the nozzle 34, and so on according to a 3D shape of a metallic product as a 3D printing target, target characteristics such as an organization, mechanical characteristics, and a composition of a material deposited on the substrate 20, a type of an electrolyte, and so on.

In particular, as in the 3D printing apparatus 10 according to an exemplary embodiment of the present invention, in a structure in which the electrolyte 12 is circulated by the electrolyte supplier 70, a temperature of the circulated electrolyte 12 is easily changed and, thus, it may be necessary to adjust the temperature of the electrolyte 12 jetted through the nozzle 34 to a temperature range within which deposition is smoothly performed according to a type of the electrolyte 12.

To this end, the 3D printing apparatus 10 according to an exemplary embodiment of the present invention may further include a temperature adjuster 80 that is disposed between the reservoir 60 and the nozzle assembly 30 and adjusts the temperature of the electrolyte 12 supplied to the nozzle assembly 30 by the electrolyte supplier 70.

The temperature adjuster 80 may include a thermoelectric device that is configured to surround a predetermined portion of a pipe 17 as a moving path in which the electrolyte 12 is circulated so as to heat or cool the electrolyte 12 moved through the pipe 17.

The 3D printing apparatus 10 according to an exemplary embodiment of the present invention may further include a temperature sensor 83 for detecting a temperature of the electrolyte 12 circulated through the pipe 17.

In this case, the controller 50 may control the temperature adjuster 80 according to the detection result of the temperature sensor 83 to adjust the temperature of the electrolyte 12 jetted to the substrate 20 through the nozzle 34.

For example, the 3D printing data input through the input unit 52 may include temperature range information of the electrolyte 12, for smoothly performing deposition according to a type of the electrolyte 12 and the controller 50 may control the temperature adjuster 80 based on the detection result of the temperature sensor 83 so as to maintain the temperature of the electrolyte 12 jetted through the nozzle 34 in the temperature range included in the 3D printing data.

The temperature range information according to a type of the electrolyte 12 may be about 35 to 55° in the case of a nickel alloy electrolyte and may be about 0 to 25° in the case of a copper alloy electrolyte.

The temperature sensor 83 may be positioned at an outlet of the temperature adjuster 80 so as to measure the temperature of the heated or cooled electrolyte 12 by the temperature adjuster 80 (refer to FIG. 1) or may be positioned at an end portion of the nozzle 34 so as to comparatively accurately measure the temperature of the electrolyte 12 jetted through the nozzle 34 but the present invention is not limited thereto.

As described above, the deposition region 14 may be a unit deposition region for 3D printing and an area of the unit deposition region 14 may be changed according to a size of a cross section of the end portion 37 of the nozzle 34.

In particular, when the size of the cross section of the end portion 37 of the nozzle 34 is constant, the area of the unit deposition region 14 may be changed according to the gap 15 between the substrate 20 and the end portion 37 of the nozzle 34 or a gap 18 between an upper surface 16 of the deposition region 14 and the end portion 37 of the nozzle 34 when the deposition region 14 is stacked to a predetermined height as illustrated in FIG. 4.

In order to enhance 3D printing precision of a metallic product, it may be necessary to form the unit deposition region 14 with a uniform area.

Accordingly, in the 3D printing apparatus 10 according to an exemplary embodiment of the present invention, it may be necessary to maintain constant the gap 15 between the substrate 20 and the end portion 37 of the nozzle 34 or the gap 18 between the upper surface 16 of the deposition region 14 and the end portion 37 of the nozzle 34 so as to form the unit deposition region 14 with a uniform area.

To this end, the 3D printing apparatus 10 according to an exemplary embodiment of the present invention may further include a measurer 90 for measuring a voltage or current between the first electrode 42 and the substrate 20 as the second electrode 43, and a gap adjuster 93 for adjusting the gap 15 between the substrate 20 and the end portion 37 of the nozzle 34. The controller 50 may control the gap adjuster 93 according to measurement of the measurer 90 to maintain constant a voltage or current between the first electrode 42 and the substrate 20 as the second electrode 43 so as to maintain constant the gap 15 between the substrate 20 and the end portion 37 of the nozzle 34 or the gap 18 between the upper surface 16 of the deposition region 14 and the end portion 37 of the nozzle 34.

Since the first electrode 42, which has a contact point with the electrolyte 12 jetted through the nozzle 34, and the substrate 20, which is the second electrode 43, are electrically connected by the electrolyte 12 jetted through the nozzle 34 and a resistance value is changed according to the gap 15 between the substrate 20 and the end portion 37 of the nozzle 34, when the power supply 40 applies a predetermined voltage, a current value between the first electrode 42 and the substrate 20 that is the second electrode 43 may be changed according to the gap 15 and, on the other hand, when the power supply 40 supplies a predetermined amount of current, a voltage between the first electrode 42 and the substrate 20 as the second electrode 43 is changed according to the gap 15 and, thus, when the gap 15 is constant, a voltage or current value between the first electrode 42 and the substrate 20 that is the second electrode 43 may be constant. That is, there may be a voltage or current value corresponding to the constant gap 15.

Accordingly, during 3D printing, upon measuring the voltage or current value in real time to check whether the voltage or current value is maintained constant, the measurer 90 may indirectly check whether the gap 15 is maintained constant as a gap corresponding to the voltage or current value and, based on this result, when the controller 50 controls the gap adjuster 93 according to the measurement result of the measurer 90, the gap 15 may be maintained constant.

In particular, in the 3D printing apparatus 10 according to an exemplary embodiment of the present invention, the gap 15 between the substrate 20 and the end portion 37 of the nozzle 34 is maintained constant in order to form the unit deposition region 14 with a uniform area. In this regard, as illustrated in FIG. 4, when the deposition region 14 is stacked to a predetermined height or more, it may be necessary to increase the gap 15 between the substrate 20 and the end portion 37 of the nozzle 34 to maintain constant the gap 18 between the upper surface 16 of the deposition region 14 and the end portion 37 of the nozzle 34.

As illustrated in FIG. 4, when the deposition region 14 is stacked to a predetermined height or more, according to reduction in a resistance value between the first electrode 42 and the substrate 20 as the second electrode 43 due to the stacked deposition region 14, a voltage difference between the first electrode 42 and the substrate 20 as the second electrode 43 is reduced or a current value is increased (when the power supply 40 applies a predetermined voltage, a current value between the first electrode 42 and the substrate 20 as the second electrode 43 is increased and, on the other hand, when the power supply 40 applies a predetermined amount of current, a voltage between the first electrode 42 and the substrate 20 as the second electrode 43 is reduced) and, accordingly, when reduction in voltage or increase in current value is measured by the measurer 90, the controller 50 may control the gap adjuster 93 to increase the gap 15 between the substrate 20 and the end portion 37 of the nozzle 34 in order to maintain constant the voltage or current (when the gap 15 is increased, a resistance value between the first electrode 42 and the second electrode 43 is increased and a voltage is increased and current is reduced and, thus, the voltage or current is maintained constant) so as to maintain constant the gap 18 between the upper surface 16 of the deposition region 14 and the end portion 37 of the nozzle 34.

That is, in the 3D printing apparatus 10 according to an exemplary embodiment of the present invention, the controller 50 may control the gap adjuster 93 to maintain constant a voltage or current between the first electrode 42 and the substrate 20 as the second electrode 43 according to measurement of the measurer 90 so as to maintain constant the gap 15 between the substrate 20 and the end portion 37 of the nozzle 34 or the gap 18 between the upper surface 16 of the deposition region 14 and the end portion 37 of the nozzle 34.

For example, the 3D printing data input through the input unit 52 may include voltage or current value information between the first electrode 42 and the substrate 20 as the second electrode 43, which needs to be maintained constant in order to form the unit deposition region 14 with a uniform area and, the controller 50 may control the gap adjuster 93 from the measurement result of the measurer 90 so as to maintain a voltage or current between the first electrode 42 and the substrate 20 as the second electrode 43 as the voltage or current value included in the 3D printing data and, thus, the gap 15 between the substrate 20 and the end portion 37 of the nozzle 34 or the gap 18 between the upper surface 16 of the deposition region 14 and the end portion 37 of the nozzle 34 may be maintained constant. Here, the voltage or current value information contained in the 3D printing data may be input in a predetermined range or may be input to be changed according to a 3D printing region but the present invention is not limited thereto.

The gap adjuster 93 may include the first driver 54 for vertically moving the nozzle 34 or the nozzle assembly 30. That is, as described above, the first driver 54 may be configured to planarly move the nozzle assembly 30 so as to planarly change a location of the nozzle 34 through which the electrolyte 12 is jetted and may also configured to vertically move the nozzle 34 or the nozzle assembly 30 so as to adjust the gap 15 between the substrate 20 and the end portion 37 of the nozzle 34.

The gap adjuster 93 may include a second driver 94 for vertically moving the support 25 for supporting the substrate 20. In this case, the controller 50 may control the second driver 94 to adjust a gap between the substrate 20 and the end portion 37 of the nozzle 34.

The gap adjuster 93 may include both the first driver 54 and the second driver 94. In this case, the controller 50 may control any one of the first driver 54 and the second driver 94 to adjust the gap between the substrate 20 and the end portion 37 of the nozzle 34.

For example, when a size and weight of a metallic product as a 3D printing target is outside a range for precisely driving the second driver 94, the controller 50 may control the first driver 54 to adjust a gap between the substrate 20 and the end portion 37 of the nozzle 34 and, when the size and weight of the metallic product are inside the range for precisely driving of the second driver 94, the controller 50 may control the second driver 94 to adjust the gap between the substrate 20 and the end portion 37 of the nozzle 34.

That is, in the 3D printing apparatus 10 according to an exemplary embodiment of the present invention, precise adjustment of the gap between the substrate 20 and the end portion 37 of the nozzle 34 is an important factor for forming the deposition region 14 with a uniform thickness and area and, thus, when it is difficult to precisely control the support 25 in a vertical direction by the second driver 94 with the size and weight of the metallic product as a 3D printing target, the first driver 54 may control vertical movement of the nozzle 34 and, when the second driver 94 is capable of being precisely controlled, vertical movement of the support 25 for supporting a metallic product as a 3D printing target may be controlled by the second driver 94.

Accordingly, the controller 50 according to the present embodiment may control any one of the first driver 54 and the second driver 94 according to the size and weight of a metallic product as a 3D printing target in order to adjust the gap between the substrate 20 and the end portion 37 of the nozzle 34.

For example, the 3D printing data input through the input unit 52 may include information about any one of the first driver 54 and the second driver 94, which is to be used as an element of the gap adjuster 93 in order to adjust the gap between the substrate 20 and the end portion 37 of the nozzle 34 and the controller 50 may control the gap using any one of the first driver 54 and the second driver 94 according to the information.

FIG. 5 is a diagram for explanation of a 3D printing apparatus according to another exemplary embodiment of the present invention.

The 3D printing apparatus according to the present embodiment is different from the aforementioned embodiments in that the 3D printing apparatus according to the present embodiment further includes a discharge nozzle 100 and, thus, a detailed description of other components and reference numerals in the drawings are substituted with the above detailed description and reference numerals.

Referring to FIG. 5, the 3D printing apparatus 10 according to the present embodiment may further include the discharge nozzle 100 for discharging liquid or gas around the deposition region 14 at a predetermined pressure.

In the 3D printing apparatus 10 according to the present invention, it is necessary to precisely perform deposition with a uniform thickness and size in the deposition region 14 in order to enhance the quality of 3D printing of the metallic product as a 3D printing target, as described above, but undesirable deposition may be performed while the electrolyte 12 gathers in a region in which deposition of metallic ions are not desired and, thus, in order to prevent this, it may be important to move gas or liquid discharged from the discharge nozzle 100 in order to facilitate rapid flow of the jetted electrolyte 12.

To this end, the 3D printing apparatus 10 according to the present embodiment may further include the discharge nozzle 100 for discharging liquid or gas to a peripheral region 19 of the deposition region 14 at a predetermined pressure.

Then, the metallic ions of the electrolyte 12 may be prevented from being deposited on the substrate 20 in the peripheral region 19 due to the liquid or gas discharged from the discharge nozzle 100 at a predetermined pressure.

When liquid or gas is discharged through the discharge nozzle 100 at a predetermined pressure, the electrolyte 12 jetted through the nozzle 34 may smoothly flow into the reservoir 60, thereby preventing the possibility of deposition that occurs when the electrolyte 12 gathers in a certain region of the substrate 20.

The discharge nozzle 100 may be configured to discharge air.

In the 3D printing apparatus 10 according to the present invention, the electrolyte 12 continuously circulates until a concentration of metallic ions of the electrolyte 12 are lowered and, thus, when the discharge nozzle 100 discharges liquid such as water, the concentration of the metallic ions of the electrolyte 12 are affected and, in this regard, since the concentration of the metallic ions of the electrolyte 12 is an important factor in affecting the deposition quality in the deposition region 14, it may not be appropriate that the concentration of the electrolyte 12 is changed by liquid discharged from the discharge nozzle 100 and, accordingly, it may be appropriate that the discharge nozzle 100 is configured to discharge air.

The discharge nozzle 100 may be positioned at an outer circumference surface of the nozzle 34 or may be integrally formed with the nozzle assembly 30 but the present invention is not limited thereto.

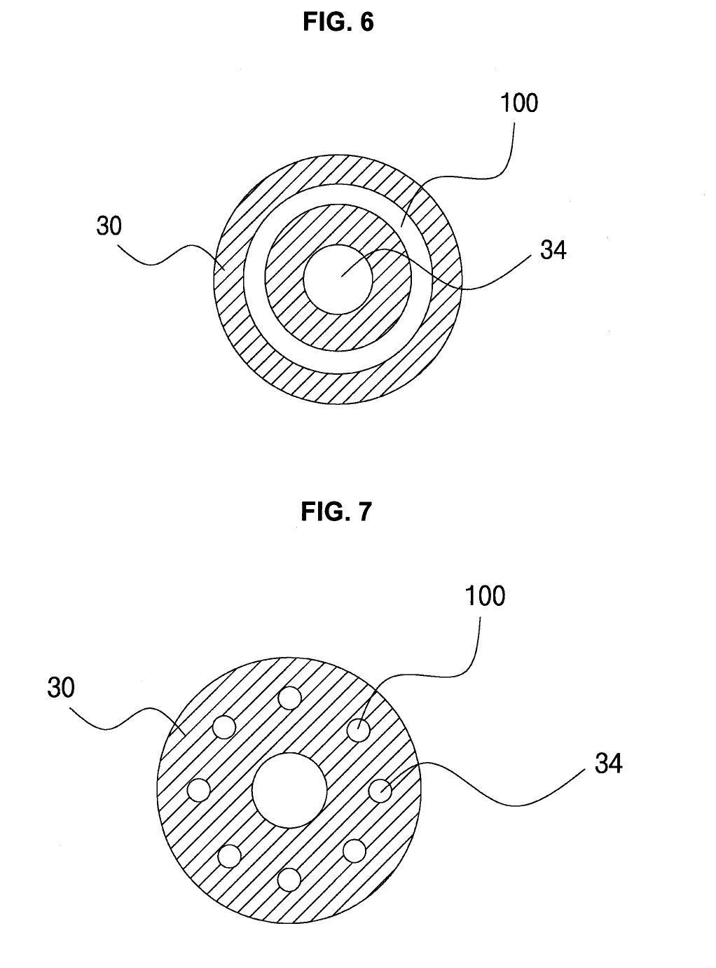

FIGS. 6 and 7 are diagrams illustrating the discharge nozzle 100 in various forms.

As illustrated in FIG. 6, the discharge nozzle 100 according to an exemplary embodiment of the present invention may have a circular band shape at an outer circumference surface of the nozzle 34 or, as illustrated in FIG. 7, the discharge nozzle 100 may be configured as a plurality of predetermined gaps at the outer circumference surface of the nozzle 34 but the present invention is not limited to a detailed structure of the discharge nozzle 100.

According to the diverse exemplary embodiments of the present invention, a 3D printing apparatus using selective electrochemical deposition may be used to selectively deposit a metallic material on a substrate using a nozzle for jetting an electrolyte at a predetermined pressure to enhance 3D printing speed of a metallic product stacked on the substrate without necessity of a high-temperature application process of sintering a metallic material.

As described above, the present invention relates to a 3D printing apparatus for selectively depositing a metallic material on a substrate using a nozzle for jetting an electrolyte at a predetermined pressure to enhance 3D printing speed of a metallic product stacked on the substrate and embodiments of the 3D printing apparatus may be changed in various forms. The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. A three-dimensional (3D) printing apparatus comprising:
a substrate;
a nozzle assembly configured to jet an electrolyte to the substrate at a predetermined pressure through a nozzle installed at an end portion of the nozzle assembly;
a power supply configured to apply a voltage or current to the electrolyte jetted through the nozzle using a first electrode that has a contact point with the electrolyte jetted through the nozzle and the substrate that is a second electrode to form a deposition region on a region of the substrate, corresponding to a jetted surface of the jetted electrolyte;
an input unit configured to input 3D printing data of a metallic product as a 3D printing target;
a first driver configured to move the nozzle assembly so as to change a location of the nozzle through which the electrolyte is jetted;
a reservoir configured to store the electrolyte jetted to the substrate;
an electrolyte supplier configured to supply the electrolyte stored in the reservoir to the nozzle assembly at a predetermined pressure; and
a controller configured to control the first driver and the power supply according to 3D printing data input through the input unit to selectively stack the deposition region deposited on the substrate,
a measurer coupled to the first and second electrodes to measure an actual voltage between the first and second electrodes; and
a gap adjuster configured to adjust a gap between the substrate and an end portion of the nozzle based on the measured voltage,
wherein when the power supply applies a predetermined current, the controller controls the gap adjuster to increase the gap when a reduction in voltage is measured by the measurer, and to decrease the gap when an increase in voltage is measured by the measurer,
wherein the controller controls the gap adjuster such that a gap between an upper surface of the deposition region and the end portion of the nozzle is unchanged.

2. The 3D printing apparatus as claimed in claim 1, further comprising:
a temperature adjuster disposed between the reservoir and the nozzle assembly and configured to adjust a temperature of the electrolyte supplied to the nozzle assembly by the electrolyte supplier; and
a temperature sensor configured to detect the temperature of the electrolyte supplied to the nozzle assembly by the electrolyte supplier,
wherein the controller controls the temperature adjuster according to detection of the temperature sensor to adjust the temperature of the electrolyte jetted through the nozzle.

3. The 3D printing apparatus as claimed in claim 2, wherein:
the 3D printing data comprises temperature range information of the electrolyte; and
the controller controls the temperature adjuster based on a detection result of the temperature sensor in such a way that the temperature of the electrolyte jetted through the nozzle is maintained in the temperature range included in the 3D printing data.

4. The 3D printing apparatus as claimed in claim 2, wherein the temperature adjuster comprises a thermoelectric device configured to surround a pipe in which the electrolyte supplied to the nozzle assembly by the electrolyte supplier is moved.

5. The 3D printing apparatus as claimed in claim 2, further comprising a discharge nozzle configured to discharge liquid or gas around the deposition region at a predetermined pressure.

6. The 3D printing apparatus as claimed in claim 5, wherein the discharge nozzle discharges air.

7. The 3D printing apparatus as claimed in claim 5, wherein the discharge nozzle is positioned at an outer circumference surface of the nozzle.

8-9. (canceled)

10. The 3D printing apparatus as claimed in claim 1, wherein the controller controls the gap adjuster to increase the gap between the substrate and the end portion of the nozzle as a height of the deposition region is stacked is increased.

11-12. (canceled)

13. The 3D printing apparatus as claimed in claim 1, wherein:
the gap adjuster is configured in such a way that the first driver vertically moves the nozzle or the nozzle assembly; and
the controller controls vertical movement of the first driver according to measurement of the measurer.

14. The 3D printing apparatus as claimed in claim 1, wherein:
the gap adjuster comprises a second driver configured to vertically move a support configured to support the substrate; and
the controller controls the second driver according to measurement of the measurer.

15. The 3D printing apparatus as claimed in claim 13, wherein:
the gap adjuster further comprises a second driver configured to vertically move the support; and
the controller controls any one of the first driver and the second driver.

16. The 3D printing apparatus as claimed in claim 1, further comprising a plurality of discharge nozzles configured to discharge liquid or gas around the deposition region at a predetermined pressure.

17. The 3D printing apparatus as claimed in claim 16, wherein the discharge nozzles discharge air.

18. The 3D printing apparatus as claimed in claim 16, wherein the discharge nozzles are positioned at an outer circumference surface of the nozzle.

19-20. (canceled)
